(19) United States
(12) Patent Application Publication
(10) Pub. No.: US 2025/0306236 A1
(43) Pub. Date: Oct. 2, 2025

(54) GAS STORAGE REAL TIME MONITORING PLATFORM

(71) Applicant: Saudi Arabian Oil Company, Dhahran (SA)

(72) Inventors: Aamir Badr, Dhahran (SA); Ziyad Alali, Dhahran (SA); Mohammad H. Altwaijri, Dhahran (SA); Laila Mira, Dammam (SA); Osamah A. Alluhaidan, Khobar (SA); Mohammed A. Suaid, Dammam (SA)

(21) Appl. No.: 18/624,401

(22) Filed: Apr. 2, 2024

(51) Int. Cl. G01V 20/00; E21B 49/00

(52) U.S. Cl. CPC G01V 20/00; E21B 49/00

(57) ABSTRACT

Methods, systems, and computer-readable storage media for receiving, from probes, probe data indicative of gas storage, the probe data being collected by probes included in operating wells and observation wells within a field, the probe data comprising surface data and subterranean data indicative of a health of a gas storage reservoir within the field. A gas storage status is determined by using a gas storage model, the gas storage model correlating the surface data and the subterranean data within the field. A gas storage assessment report including a pressure map reflecting the gas storage status within the field is provided.

### TECHNICAL FIELD

This disclosure relates to gas storage real time monitoring systems and, more specifically, to gas storage models used to update reservoir management plans.

### BACKGROUND

Well management, stability, and safety can be affected by many field conditions, including gas (hydrocarbon) storage. Injection rates and areas can lead to changes in pressure within the field. The physical characteristics of the reservoir change during this phase. These characteristics can further change during re-production phase that follows injection. Speculation of physical changes during re-production can lead to a reservoir characterization that can greatly differ from the physical reservoir pore pressure and geostress.

### SUMMARY

Implementations of the present disclosure are directed to gas storage real time monitoring. More particularly, implementations of the present disclosure are directed to gas storage models used to update reservoir management plans.

In some implementations, a method includes: receiving, by one or more processors from probes, probe data indicative of gas storage, the probe data being collected by probes included in operating wells and observation wells within a field, the probe data including surface data and subterranean data indicative of a health of a gas storage reservoir within the field; determining, by the one or more processors, by using a gas storage model, a gas storage status, the gas storage model correlating the surface data and the subterranean data within the field; providing, by the one or more processors, a gas storage assessment report including a pressure map reflecting the gas storage status within the field; and triggering, by the one or more processors, an operation affecting the gas storage within the field.

The foregoing and other implementations can each optionally include one or more of the following features, alone or in combination. In particular, implementations can include all the following features:

In a first aspect, combinable with any of the previous aspects, wherein the probe data includes wellhead data, downhole parameters, and micro-seismic data. The computer-implemented method further includes: determining, by the one or more processors, that the probe data is outside an operational range; and generating, by the one or more processors, an alert for transmission to one or more computing devices. The gas storage status includes sustainability, integrity, and safety of gas storage surface and subterranean assets. The computer-implemented method further includes: determining, by the one or more processors, that the gas storage status is outside an operational range; and generating, by the one or more processors, an action plan including one or more remediation operations. The computer-implemented method further includes: transmitting, by the one or more processors, the one or more remediation operations configured to adjust at least one configuration setting of at least one of one or more devices. The computer-implemented method further includes: determining, by the one or more processors, consequences associated with the action plan. The computer-implemented method further includes: updating, by the one or more processors, the gas storage model based on the consequences associated with the action plan. The operation includes a reservoir management operation, an injection strategy, or a re-production strategy.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Implementations described in the present disclosure, provide multiple technical advantages. For example, the gas storage real time monitoring described in the present disclosure is based on data received from the wells with various sensors, including pressure, temperature, acoustic and seismic. The gas storage models integrate surface and subterranean data for determining reservoir characteristics, rather than disjointly treating surface data and subterranean data, which can lead to significant errors in characterization of reservoirs and wells. Configurations of the gas storage models can be adjusted to reflect particular field characteristics (e.g., characteristics of reservoirs and wells) relative to most current well and reservoir compliance requirements that are associated to highest security and safety standards. Another advantage of the described technology is that it provides key recommended actions for improving field (well and reservoir) safety and security to ensure continuation of well operations. Furthermore, the described reservoir characteristic assessment approach allows a continuous training of machine learning models that are integrated in gas storage models. Fine tuning of machine learning models can maximize the safety breach prevention. Moreover, collaboratively training the machine learning models can promote optimal threat prevention performance in view of evolving conditions leading to potential safety breaches. Another advantage of the described technology is that the described reservoir characteristic assessment allows users (e.g., geomechanical managers) to optimize gas storage model settings or to optimize other aspects of machine and device operations for continuation of operation of wells and optimization of reservoir management.

The details of one or more implementations of the subject matter of the specification are set forth in the accompanying drawings and the description below. Other features, aspects, and advantages of the subject matter can become apparent from the description, the drawings, and the claims.

### DESCRIPTION OF DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure;

FIG. 1B is a block diagram of a portion of the example system that can be used to execute implementations of the present disclosure;

FIG. 2A illustrates an example of a graphical user interface of the example system that can be used to execute implementations of the present disclosure;

FIG. 2B illustrates another example of a graphical user interface of the example system that can be used to execute implementations of the present disclosure;

FIG. 3 depicts a flowchart illustrating an example process for gas storage real time monitoring, in accordance with some example implementations;

FIG. 4 depicts a block diagram illustrating a computing system, in accordance with some example implementations; and

FIG. 5 illustrates hydrocarbon production operations, in accordance with some example implementations.

When practical, like labels are used to refer to same or similar items in the drawings.

### DETAILED DESCRIPTION

Implementations of the present disclosure are directed to gas (hydrocarbon) storage real time monitoring. More particularly, implementations of the present disclosure are directed to gas storage models used to update reservoir management plans, by correlating surface data to subterranean data, collected by probes, within an industrial field. The probes can be attached to or integrated in operating wells and observation wells within the industrial field. The probes collect probe data including gas storage related data, such as the surface data and the subterranean data indicative of a health of a hydrocarbon reservoir within a region of the field. The probe data can be provided as input to automatically update gas storage models. The gas storage models represent characteristics of hydrocarbon reservoirs (subterranean volumes of the earth) in relation to well features, production operations, and micro-seismic activities. The characteristics of hydrocarbon reservoirs monitored and estimated by the gas storage models include field parameters, such as gas rates, pressure, temperatures, and micro-seismic measurements. The reservoir pressure estimated, using gas storage models, is monitored to identify a potential reservoir pressure limitation breach and to forecast reservoir pressure during each injection and re-production cycle in parallel to a performance analysis of wells and hydrocarbon reservoirs. The characteristics of hydrocarbon reservoirs monitored and estimated by the gas storage models can guide updates of the reservoir management plans including injection and re-production rates.

Addressing the challenges of field monitoring complexity, the gas storage models described in the present disclosure enable accurate representation of hydrocarbon reservoir characteristics. The gas storage models integrate surface data and subterranean data for determining the hydrocarbon reservoir characteristics. The determined hydrocarbon reservoir characteristics are compared to safety limits to invoke safety protocols and to identify action plans to improve the safety and security of wells and hydrocarbon reservoirs.

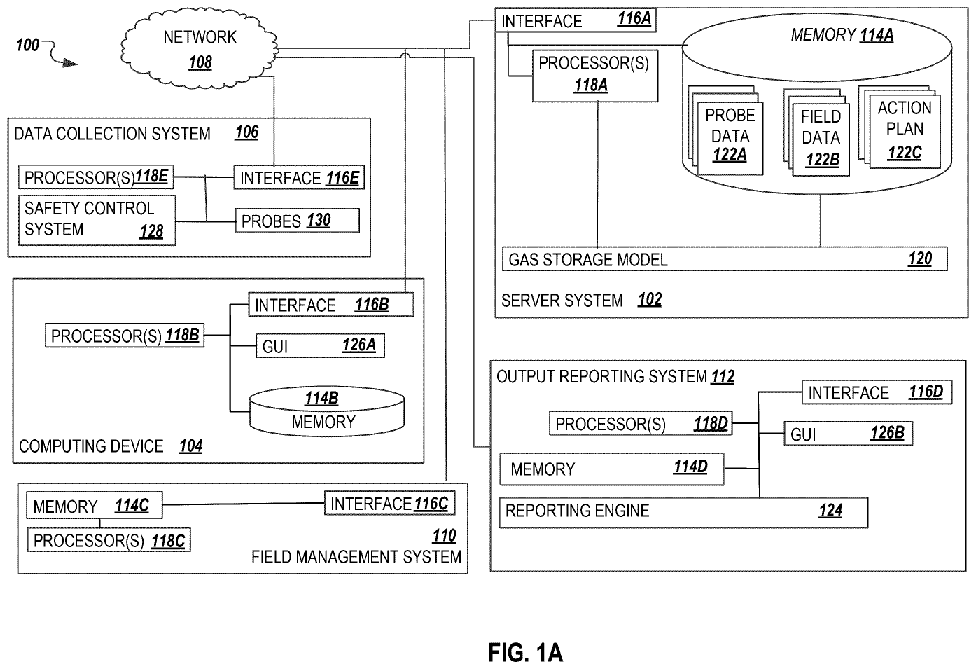

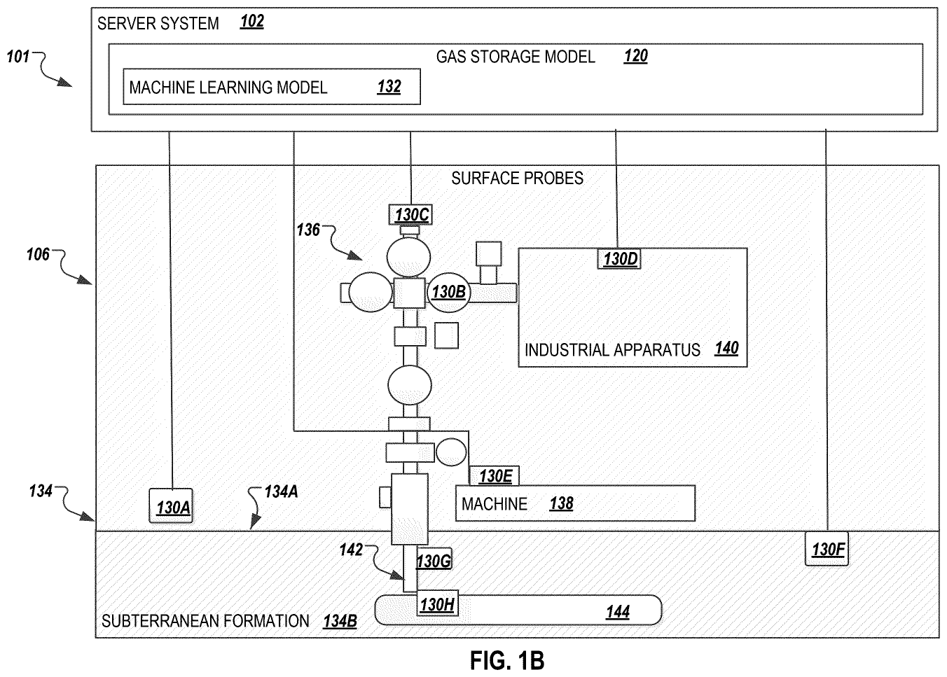

An advantage of the implementations described in the present disclosure is that the gas storage models integrate surface and subterranean data for determining hydrocarbon reservoir characteristics, rather than analyzing surface data separate from subterranean data, which can lead to significant errors in hydrocarbon reservoir characterization. Configurations of the gas storage models can be adjusted to reflect particular field characteristics relative to most current well and hydrocarbon reservoir compliance requirements that are associated to highest safety standards. Another advantage of the described technology is that it provides key recommended actions for improving field (well and hydrocarbon reservoir) safety to ensure optimization and continuity of well operations. Furthermore, the described hydrocarbon reservoir assessment approach allows a continuous training of machine learning models that are integrated in gas storage models. Fine tuning of machine learning models can maximize the accuracy of hydrocarbon reservoir characterization. Moreover, collaboratively training the machine learning models can promote optimal accident prevention performance in view of evolving conditions leading to potential safety breaches. Another advantage of the described technology is that the described hydrocarbon reservoir characteristic assessment allows users (e.g., reservoir management team) to optimize gas storage model settings or to optimize other aspects of machine and device operations for continuation of operation of wells and optimization of hydrocarbon reservoir management. Other advantages of the gas storage real time monitoring techniques are described with reference to FIGS. 1A-1B, 2A-2B, and 3-4.

FIG. 1A is a block diagram illustrating an example system 100 for gas storage real time monitoring within fields including one or more wells and one or more hydrocarbon reservoirs). Specifically, the illustrated example system 100 includes or is communicably coupled with a server system 102, a computing device 104, a data collection system 106, a network 108, a field management system 110, and an output reporting system 112. Although shown separately, in some implementations, functionality of two or more systems or components of the example system 100 can be provided by a single system or server. In some implementations, the functionality of one illustrated system, server, or component can be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages gas storage real time monitoring within gas fields for management of well operations using any number of components of the example system 100 including computing devices 104 (e.g., over the network 108). In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes.

The server system 102 includes a memory 114A, an interface 116A, a processor 118A, and a gas storage model 120. The memory 114A can store data (e.g., inputs and outputs of the gas storage model 120), such as probe data 122A, field data 122B, and action plans 122C. The probe data 122A can be received from the data collection system 106. The probe data 122A can include live monitoring data, such as seismic data and pressure data. The field data 122B can include a storage profile, storage performance, past alerts, and references to external regulation safety resources, which can be analyzed, by the gas storage model 120. In some implementations, an alert generation defined by the action plans 122C can also point to an internal security regulation set within the example system 100 (e.g., regulations adjusted to reflect the vulnerabilities of the field management system 110). The action plans 122C in the memory 114A can include action plan documents defining threat prevention mechanisms including operations that can be performed by the components the example system 100 to annihilate detected or estimated unsafe operations. The gas storage model 120 can process data, obtained from the memory 114A, using machine learning models to analyze wells and hydrocarbon reservoirs within a field and to monitor gas storage in real time for generating output signals for the field management system 110 according to the action plans 122C.

The computing device 104, the field management system 110, and the output reporting system 112 can each be any computing device operable to connect to or communicate in the network(s) 108 using a wireline or wireless connection. In general, each of the computing device 104, the field management system 110, and the output reporting system 112 includes an electronic computer device operable to receive, transmit, process, and store any appropriate data associated with the example system 100 of FIG. 1A. Each of the computing device 104, the field management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the field management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including gas storage real time monitoring data (reports), and/or well operations, respectively. The GUIs 126A, 126B each interface with at least a portion of the example system 100 for any suitable purpose, including generating a visual representation of the data collected by the data collection system 106, data generated by the server system 102, or data stored by the server system 102, such as probe data 122A, field data 122B, and action plans 122C, respectively. In particular, the GUIs 126A, 126B can each be used to view and adjust various gas storage management operations. Generally, the GUIs 126A, 126B each provide the user with an efficient and user-friendly presentation of gas storage real time monitoring provided by or communicated within the example system 100. The GUIs 126A, 126B can each include multiple customizable frames or views having interactive fields, pull-down lists, and buttons operated by the user. The GUIs 126A, 126B can each be any suitable graphical user interface, such as a combination of a generic web browser, intelligent engine, and command line interface (CLI) that processes information and efficiently presents the results to the user visually.

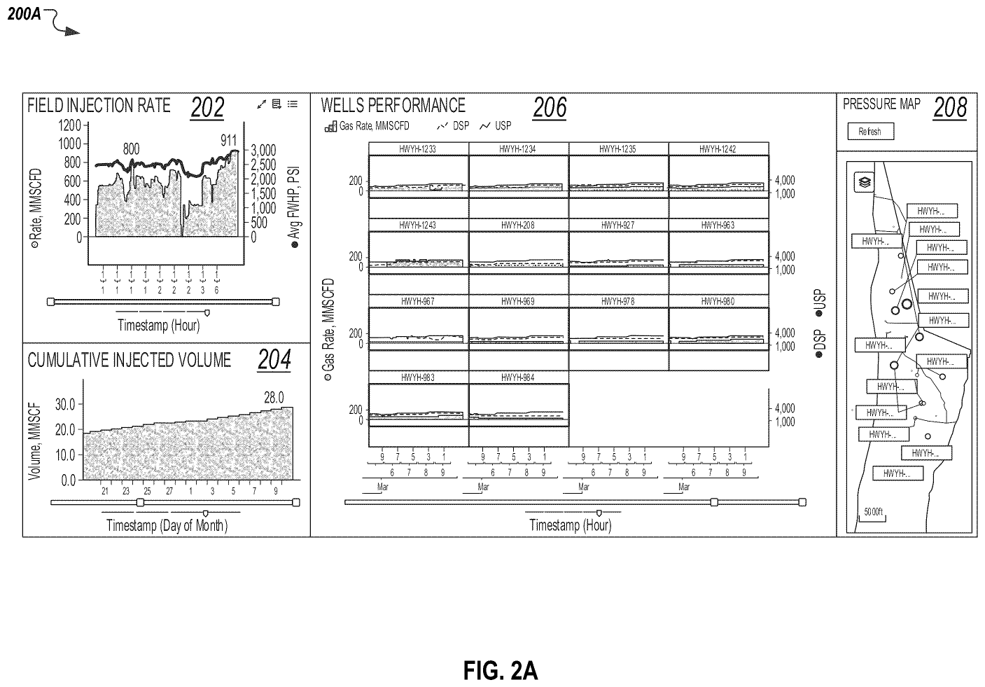

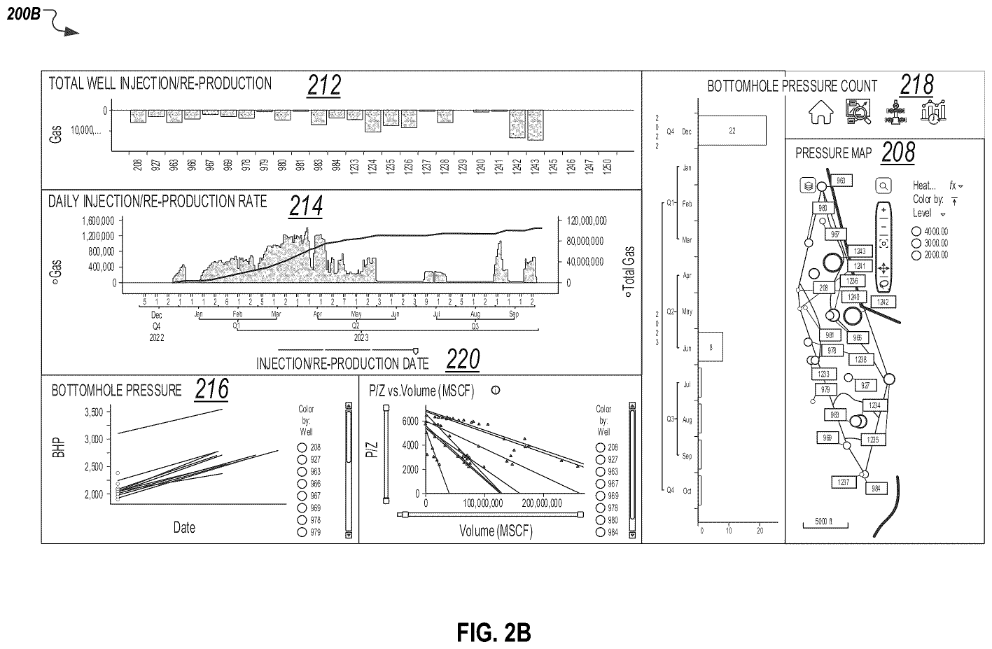

The output reporting system 112 can include a reporting engine 124, the GUI 126B (dashboard), a user module, and administrator modules. The reporting engine 124 utilizes the analytics data provided by the gas storage model 120 to produce alerts to be displayed by the GUI 126B. The GUI 126B displays information related to the gas storage real time monitoring, as described with reference to FIGS. 2A and 2B. The GUI 126B display can enable well management by supporting modification of well operations.

The data collection system 106 can include a safety control system 128 and multiple probes 130. The safety control system 128 controls operation of the probes 130 and directs collected data to the server system 102 for storage, further analysis and correlations. The probes 130 can collect surface data and subterranean data within a field including one or more wells and one or more hydrocarbon reservoirs. The probes 130 can be coupled to or integrated in different types of components of the wells, to continuously monitor gas storage and secure the safety of the field operations. Further details about the probes 130 and their operation are provided with reference to FIG. 1B.

In some implementations, the network 108 can include a large computer network, such as a local area network, a wide area network, the Internet, a cellular network, a telephone network or an appropriate combination thereof connecting any number of communication devices, mobile computing devices, fixed computing devices and server systems. Data exchanged over the network 108, is transferred using any number of network layer protocols, such as internet protocol, multiprotocol label switching, asynchronous transfer mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit (CPU), an application specific integrated circuit (ASIC), a field-programmable gate array (FPGA), or another suitable component. Generally, each processor 118A, 118B, 118C, 118D, 118E executes instructions and manipulates data to perform gas storage real time monitoring within fields. For example, each processor 118A, 118B, 118C, 118D, 118E executes a functionality required to monitor gas storage in real time within fields, to plan well configurations, to execute well operations and to maintain safety of field operations.

Interfaces 116A, 116B, 116C, 116D, 116E are used by different components of the example system 100 for communicating with other component systems in a distributed environment-including within the example system 100-connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E can each include software supporting one or more communication protocols associated with communications such that the network 108 or interface's hardware is operable to communicate physical signals within and outside of the illustrated system 100.

The memory 1114A, 114B, 114C, 114D can include any type of memory or database module and can take the form of volatile and/or non-volatile memory including, without limitation, magnetic media, optical media, random access memory (RAM), read-only memory (ROM), removable media, or any other suitable local or remote memory component. The memory 1114A, 114B, 114C, 114D can store various objects or data, including caches, classes, frameworks, applications, backup data, business objects, jobs, web pages, web page templates, database tables, database queries, repositories storing safety data and/or dynamic information, and any other appropriate information including any parameters, variables, algorithms, instructions, rules, constraints, or references thereto associated with the purposes of the server system 102, the computing device 104, the data collection system 106, the field management system 110, and the output reporting system 112, respectively.

There can be any number of computing devices 104 and data collection systems 106 associated with, or external to, the example system 100. Additionally, there can also be one or more additional client devices external to the illustrated portion of system 100 that are capable of interacting with the example system 100 via the network(s) 108. Further, the term “client,” “client device,” and “user” can be used interchangeably as appropriate without departing from the scope of the disclosure. Moreover, while client device can be described in terms of being used by a single user, the disclosure contemplates that many users can use one computer, or that one user can use multiple computers. As used in the present disclosure, the term “computer” is intended to encompass any suitable processing device. For example, although FIG. 1A illustrates a single server system 102, a single computing device 104, a single data collection system 106, a single field management system 110, the example system 100 can be implemented using a single, standalone computing device, two or more server systems 102, or multiple client devices. The server system 102, the computing device 104 and the output reporting system 112 can include any computer or processing device. According to one implementation, the server system 102 can also include or be communicably coupled with an e-mail server, a Web server, a caching server, a streaming data server, and/or another suitable server, as described with reference to FIG. 1B.

To further illustrate, FIG. 1B depicts a schematic diagram illustrating an example portion 101 of the example system 100 described with reference to FIG. 1A, in accordance with some example implementations. The example portion 101 of the example system 100 illustrated in FIG. 1B includes the server system 102 and the data collection system 106. The server system 102 includes the gas storage model 120 that includes a machine learning model 132. The gas storage model 120 processes data collected by the probes 130A-130H within a field 134 including a surface region 134A and a subterranean formation 134B.

The probes 130A-130H can be used to measure gas storage data including surface data and petrophysical reservoir properties of subterranean formations. The surface data can include pressure data and flow data measured by probes 130A-130E distributed across a surface 134A of the analyzed field 134, a wellhead 136, a machine 138, and/or an industrial apparatus 140. The subterranean data can include information such as seismic data, pressure data, and/or flow data, image logs that can be used to monitor pressure distribution, stress changes and locating and measuring induced seismic events to update the geomechanical model.

The probes 130A-130H can be static or mobile sensors recording data at a fixed location or multiple locations within the field 134. The probes 130A-130H can record data according to a set frequency and/or a schedule and can transmit the collected data in real time (within less than a second after data collection) to the server system 102 to be processed by the gas storage model 120. The probes 130A-130H can be wired or wirelessly connected to the network 108 to transmit the collected data to the server system 102.

The probes 130A-130E, collecting surface data, can be located above the subterranean formation 134B, at the surface 134A. The probes 130A-130E can be coupled to (e.g., integrated in) monitored systems (e.g., the wellhead 136, the machine 138, and/or the industrial apparatus 140) or can be separate measurement devices or imaging tools located at particular points of interest within the surface 134A that can correspond to one or more different areas within a geographical region of the field 134. For example, one or more probes 130A can be installed near the wellhead 136 to detect surface pressure at the wellhead 136. The probes 130B, 130C can be connected to the wellhead 136 (e.g., near a valve or a flowline) to monitor a property of a fluid flowing though the corresponding portion of the wellhead 136 (e.g., from the wellhead 136 through a flowline, to the industrial apparatus 140 or the machine 138). The probe 130E can be connected to the machine 138. The probe 130D can be connected to the industrial apparatus 140.

The probes 130F, 130G, 130H, collecting subterranean data, can be located within the subterranean formation 134B. For example, one or more probes 130F can be installed near the wellbore 142 to detect subterranean data (e.g., temperature, acoustic data, seismic data and/or pressure data) in the proximity of the wellbore 142. The probes 130G, 130H can be fixed at particular locations within the well or some probes (e.g., pressure probes) can be attached to a downhole tool that can be lowered into the wellbore 142 to perform subterranean data measurements (e.g., fluid and/or formation measurements). In some examples, the probes 130A-130H can be a single device that is transportable to measure surface and reservoir data for each formation of the subterranean region 134B. The probe 130H can be located proximal to the hydrocarbon reservoir 144. A subterranean formation including a hydrocarbon reservoir 144 can have a natural fault and fracture network, where faulting and fracturing can most likely occur. The formation data measured by the probes 130G, 130H can be used to determine the reservoir conditions. Three-dimensional models of the subterranean formations can be generated by the gas storage model 120 using the formation data measured by the probes 130A-130H. The three-dimensional models can illustrate the natural fracture network, which can be used alongside the regional stress information of the geographical region of the field 134 to determine local stress variation. The local stress variation, or geomechanical strip, can be defined as a difference between the maximum and minimum stress within an area. The local stress variation can be used as a baseline for considering gas storage parameters when determining an optimized well configuration. The formation data measured by the probes 130G, 130H, within the subterranean formations can have different petrophysical properties and three-dimensional characteristics along various areas. For example, the area of the hydrocarbon reservoir 144 that can be detectable beneath the surface 134A by the probe 130H can include a larger volume of hydrocarbons than an area of the reservoir 144 that can be detectable beneath the surface 134A by the probe 130F. By determining the extent of the reservoir 144 through mapping a complete picture of the subterranean formations within a local area, a basic understanding of which locations can be drilled to achieve a highest hydrocarbon recovery rate can be determined.

In some examples, preexisting wells in the drilling or production phases can be used to provide additional data for optimizing placement of additional wells for the respective reservoir 144 already producing hydrocarbons. For example, a drilling environment can include a drilling rig in the drilling phase. During the drilling phase, sensors located at the surface 134A or downhole within the subterranean region 134B, such as sensors attached to a tool on a drill string or sensors attached to a wireline tool, can be used to determine the actual petrophysical properties of the reservoir 144. Additionally, reservoir properties can be determined in the production phase. By measuring the actual properties of a reservoir, the gas storage model 120 can include the well location and geometry of the existing well in the drilling environment within the optimization calculations.

The gas storage model 120 can process data collected by the probes 130A-130H to determine additional well placements and geometries to further maximize the hydrocarbon recovery rate for the respective reservoir 144. For example, based on the well placement and geometry of the well in the drilling environment of the field 134, the gas storage model 120 can determine that one or more wells with particular geometries and placed at particular locations can maximize the existing hydrocarbon injection and re-production rate.

The gas storage model 120 can process data collected by the probes 130A-130H using the machine learning model 132 to evaluate injection efficiency, re-production rates, and to forecast pressures within the field 134. In some implementations, the machine learning model 132 is based on machine learning techniques related to a deep neural network (DNN). A deep neural network can be referred to as a network because it can be represented by connecting different functions. For example, a model of the DNN can be represented as a graph representing how the functions are connected from an input layer, through one or more hidden layers, and finally to an output layer, and each layer can have one or more nodes. In an example, the DNN of the subject technology generates dynamic property(s) of the hydrocarbon reservoir model calibrated to the input static parameters of the flow simulator, e.g., permeability field, with low computational requirements. The DNN model can represent the relationship between static and dynamic geomechanical parameters, matching pressure data corresponding to optimize safe production to parameters of the reservoir model, such as petrophysical properties derived from the data collected by the probes 130A-130H.

In one or more implementations, relationships between the received geologic data and the injection/re-production data can be determined during training of the DNN. The training step optimizes the weights and biases in the hidden and output layer such that the estimation error between the estimated property values and observed property values from the well log(s) can be minimized. Estimation error can be root mean square deviation, or a composite of root mean square deviation, cross-correlation, or a geoscience error metric. To avoid overfitting during training, regularization of the estimation error is performed based upon the norms of weights in the hidden layers that are added to the estimation error. An optimization process can include application of a stochastic gradient descent algorithm (or any other appropriate optimization algorithm), which can use one or more iterative optimization techniques and/or use a small subset of the training dataset or batch with training samples randomly selected at a time. The variances calculated based upon the horizontal and vertical semi-variograms are included in the input feature. The optimization process can optimize the weights and biases associated with the vertical and horizontal semi-variances, and other input features such that an error in the property estimates relative to the observed property values can be minimized. The process of training described here not only can minimize the error in property estimates, but also can incorporate spatial variance of the geomechanical properties within the field 134. Following the completion of training that can be determined by the estimation error on the validation dataset falling below a cut-off value, the testing dataset can be used to determine the performance of the trained DNN on unseen well logs (e.g., not used for training). The trained DNN provides the ability of predicting the petrophysical and geomechanical property values at random 3D points in the region of interest based on the nearest neighbor points.

The DNN can determine a nonlinear relationship between input parameters (data collected by the probes 130A-130H) and model response by fitting a model to a training set of the available flow simulation runs, which is a subset of all runs (e.g., approximately 60%-80%). The model can be represented by a set of weights that are used to weigh nonlinear transform of input parameters as a weighted sum. The weighted sum represents an estimate of the output parameters from the flow simulation runs that are fitted to match recorded target output parameters as closely as possible. The remaining set of the flow simulation runs can be utilized for the testing and cross-validation of the trained DNN model. Once the DNN model is deemed to adequately describe relationship between static and dynamic parameters of the dynamic system in time, the DNN model is used for the history matching, given that the injection and re-production configurations do not change on the field 134 (e.g., the number of wells remains the same for subsequent time steps, the production operation stays the same for these wells in subsequent time steps, etc.).

Although a DNN was discussed for the purposes of explanation, it is appreciated that the machine learning model 132 can include other trainable machine learning techniques. Further, it is appreciated that other types of neural networks can be utilized by the subject technology. For example, a convolutional neural network, regulatory feedback network, radial basis function network, recurrent neural network, modular neural network, instantaneously trained neural network, spiking neural network, regulatory feedback network, dynamic neural network, neuro-fuzzy network, compositional pattern-producing network, memory network, and/or any other appropriate type of neural network can be utilized.

FIGS. 2A and 2B illustrate examples of a graphical user interfaces 200A, 200B of the example system that can be used to execute implementations of the present disclosure. The graphical user interfaces 200A, 200B can be any of the GUIS 126A, 126B, described with reference to FIGS. 1A and 1B. The graphical user interface 200A, shown in FIG. 2A, can be used to monitor gas storage well parameters in real time during an operation (e.g., injection or re-production). The graphical user interface 200A can display data obtained from a database (e.g., memory 114A, described with reference to FIG. 1A) and data (e.g., wellhead and downhole parameters) collected by the probes 130A-130H, described with reference to FIGS. 1A and 1B. The graphical user interface 200A can include an interactive module that can display a single well or multiple wells or field average depending on a selection included in a user input. For example, the graphical user interface 200A can display a field injection and re-production rate graph 202, a cumulative injected and re-production volume graph 204, a well performance graph 206, and a pressure map 208. The field injection and re-production rate graph 202, the cumulative injected and re-produced volume graph 204, and the well performance graph 206 can represent respective measured data as a function of time within a time interval that can be adjusted in response to a user input. The well performance graph 206 can display the variation of the gas rate at multiple wells, each well that is identified by a well identifier (an alpha numeric identifier). The pressure map 208 can be displayed as labeled representation of pressure values overlaying a geographical representation of a region of interest of a field, the labeling including the respective well identifiers.

The graphical user interface 200B, shown in FIG. 2B, can be used to monitor hydrocarbon reservoir pressure in real time. The graphical user interface 200B can display data used for evaluating injection and re-production and to forecast pressures (e.g., data generated by the machine learning model 132, described with reference to FIG. 1B). For example, the graphical user interface 200B can display a total well injection/reproduction graph 212, a daily well injection/reproduction graph 214, a bottomhole pressure graph 216, a bottomhole pressure count graph 218, and the pressure map 208. The daily well injection/reproduction graph 214 can represent measured data as a function of injection/reproduction dates 220 that can be adjusted in response to a user input. A key feature of the user interfaces 200A, 200B is the ability to set alerts and notifications for particular thresholds or changes of certain operational parameters ensuring the sustainability, integrity and safety of the gas storage surface and subsurface assets.

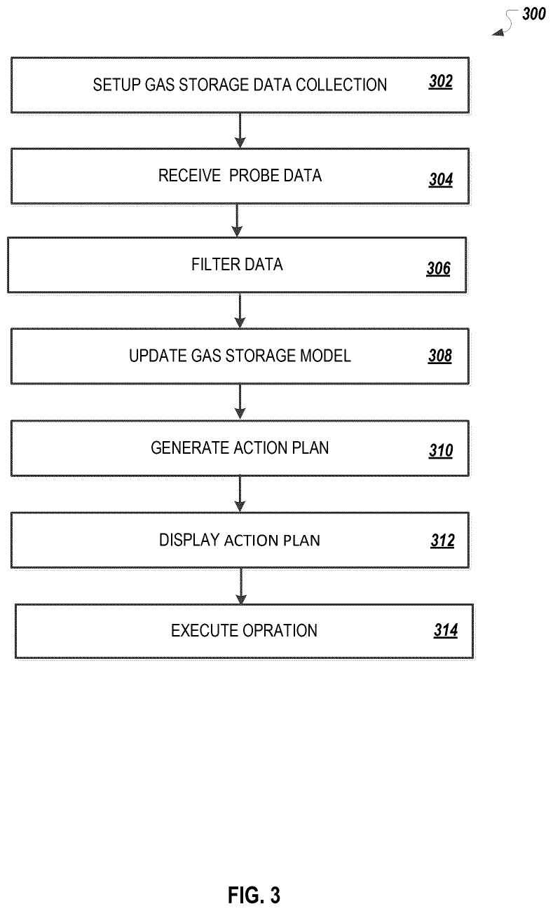

FIG. 3 depicts a flowchart illustrating an example process 300 for gas storage real time monitoring, in accordance with some example implementations. Referring to FIGS. 1A and 1B, the process 300 can be performed by any components of the example system 100. The example process 300 can be executed using, e.g., any component of the example system 100 described with reference to FIG. 1A or example system 101 described with reference to FIG. 1B. Operations of the process 300 are described below for illustration purposes only. Operations of the process 300 can be performed by any appropriate device or system, e.g., any appropriate data processing apparatus. Operations of the process 300 can also be implemented as instructions stored on a computer readable medium which can be non-transitory. Execution of the instructions causes one or more data processing apparatus to perform operations of the process 300.

At 302, collection of data using multiple probes is configured, by one or more processors configured to manage probe data collection. The management of probe data collection can include setting up a frequency and/or a schedule of collecting data from the probes as described with reference to FIGS. 1A and 1B. Each of the probes can be configured to activate data collection and/or transmission according to a respective schedule defining a frequency of data collection and a duration of each collection duration. The probes can be configured to collect data continuously (according to the respective schedule) or can have a set trigger that initiates data collection in response to detection of one or more conditions for data collection. The conditions can be defined based on safety regulations and industrial plant operational conditions regarding an operational status (e.g., fully operational, partly operational, or minimally operational) one or more components of the industrial plant (e.g., example system 100 described with reference to FIGS. 1A and 1B). In some implementations, a list of safety standards and controls are processed to initiate a real time safety compliance assessment identifying the target system components and coupled probes to be activated for collecting probe data. The probe data can be collected by probes included in operating wells and observation wells within a field. The probe data can include surface data collected by probes located on or near a wellhead and subterranean data located within or near a downhole, the probe data being indicative of a health of a gas storage reservoir within the field. For example, the probe data can include field injection and re-production rate, injected and re-produced volume, well performance parameters, pressure measurements at different locations, temperatures at multiple locations, seismic (microseismic) data, bottomhole pressure, fluid composition, flow rate, reproduction rate, and any other measurable variable parameter indicative of a well operation and/or efficiency.

At 304, the probe data is received, by the one or more processors of a server system configured to process the probe data. The received probe data can be prefiltered by the probes that generated the probe data. For example, for conserving system resources by minimizing network traffic, a portion of the probes can be configured to transmit only anomalous data potentially indicative of a safety threat or operational threat. The anomalous data can be identified as data outliers and/or data having one or more characteristics (frequency and/or amplitude) outside of an expected range. For example, the probes can include a high pass filter or a low pass filter to separate the anomalous data from normal operational data.

At 306, the probe data is filtered and aggregated, by the one or more processors of the server system configured to process the probe data. Probe data filtering can include applying filters based on well characteristics and/or machine operational patterns to the probe data to generate filtered probe data. Aggregation of the filtered probe data can include aggregation of filtered probe data per well or per reservoir. The aggregated data includes a compilation from similar data sets and aggregation of common data structures to generate relevant cumulative data, such as cumulative injected and re-produced volumes per individual wells. The aggregation of filtered probe data can be contained within a data structure, and it can be collectively aggregated to provide a robust and layered well and reservoir evaluation. In some implementations, the aggregation can include a collection of surface data that is separately aggregated from the subterranean data.

At 308, the gas storage model (e.g., the gas storage model 120 described in FIGS. 1A and 1B) is automatically updated by processing the aggregated data. Processing the aggregated data can include correlation of the surface data with the subterranean data within the field, to determine field (e.g., geomechanical) parameters indicative of the well health and reservoir integrity. Determining field parameters for analysis of the well health and reservoir integrity includes identification of well and reservoir vulnerabilities. Data correlation can include analyzing the aggregated data to determine a safety score indicative of the well health and reservoir integrity. In some implementations, the data correlation includes correlating, using prediction models (including trainable machine learning models, as described with reference to FIG. 1B), subterranean microseismic data to well and reservoir characteristics connected to determine the integrity of the reservoir. The correlation can identify a connection between a safety risk and a system component or a group of system components that can be simultaneously exposed to an operational risk. The identified connection or correlation of vulnerability to a well operation, facilitates complementation of an action plan to address the identified risk. The correlation of the aggregated data can be performed using a machine learning model configured to identify a connection between a safety risk, a well operation, and a reservoir integrity. The machine learning model can include a machine learning model pre-trained and fine-tuned to identify the connection between the safety risk, the well operation, and the reservoir integrity by interpreting patterns of the aggregated data within the context of different risk types as defined by risk scenarios obtained from a database.

At 310, an action plan is generated, by the one or more processors of the server system, to correct the determined well and/or reservoir vulnerabilities. The safety compliance score of the determined well and/or reservoir vulnerabilities can be compared to a reference score of the respective vulnerability type. The reference scores can be obtained from a database that stores the reference scores associated with a particular well or set of wells within a region of interest of a field. The reference scores represent a sustainability, integrity, and safety of the gas storage surface and subterranean system components. The difference between measured scores and reference scores can be quantified to identify the gaps indicative of compliance targets. The safety gap can be classified as minor, average or critical. The safety gap can be corrected using recommended remediation actions to increase the level of integrity and safety of well and reservoir operations to reach a target safety level. The action plan can be identified by machine learning models (e.g., recurrent neural networks with a multi-layer network topology) trained and fine-tuned to generate a set of remedial actions to correct safety gaps. The system can determine scores for each system component to be validated based on a difference between each predicted value and the target safety level for the respective component, and the accuracy for the machine learning model that generated the predicted value. The trained machine learning models can be configured to operate in active mode, within the server system, facilitating automatic action plan implementation. For example, the trained machine learning models can trigger a modification of system component operations for adjusting pressure, temperature, and/or volume, for example by valve and/or pump control. In some implementations, more than one trained machine model can be placed in active mode concurrently (that is, overlapping in a time), for example, for evaluating well operation safety considering different evaluation methods (e.g., one analyzing pressure, another analyzing temperature, another analyzing injected volume relative to a detected parameter, such as seismic data magnitude).

At 312, the action plan is transmitted to be displayed by a graphical user interface. The action plan includes an automatic selection of remedial actions that can be triggered to be automatically performed based on system configurations. Remedial actions include, among other things, notification to an end user of an identified risk, compensation through well operation adjustment to mitigate the detected risk, and communication of the sensed vulnerability and risk to a field operator or well manager to fortify the safety and integrity of the well and of the reservoir. In some implementations, transmission for display of action plans and the remedial actions can be adjusted relative to a traffic light system that categorizes safety events (e.g., microseismic events) relative to determined potential consequences associated with the action plan. For example, automatic alerts can be sent by email and text messages for minor and medium level safety risk incidents associated to consequences indicative of well operation inefficiency and automatic performance of one or more operations can be implemented for critical events associated to potentially critical consequences suggesting a current or future well inoperability or potentially leading to critical events leading to destruction of well and reservoir. The alerts can be displayed as a notification summarizing the detected risk, such as a notification indicating that gas storage status is approaching a limit of an operational range for a particular location.

At 314, in response to receiving a user input including a selection of a remediation operation or in response to determining that the remediation action plan addresses one or more critical events, the remediation operation is executed. The remediation operation can include a modification of a component of the system (adjustment of at least one device configuration setting), such as partly or completely closing one or more valves to regulate flow through the well, or activating or modifying parameters of a pump to control a flow rate. In response to executing the operation, an updated safety score can be determined and compared to the reference safety score. The comparison can indicate a success level of the remediation action plan and consequences can be used for further training of the machine learning models. If the updated safety score is greater than or equal to the reference safety score, a safety assessment report is provided for display, to the graphical user interface. The safety assessment report can be provided as a full or as a partially customized assessment. For example, the graphical user interface provides customizable features used for configuring the assessment reporting results and recommendations to monitor the health of the gas storage reservoir and well operation safety.

The example process 300 allows remotely configuring probes for collection of safety data including a broad spectrum of information by gathering probe data from different types of probes. The safety assessment can be scheduled and automated, being initiated with probe data collection. The example process 300 provides accurate and consistent assessment results, by applying quantifiable measures of safety and comparisons to (national and international) standards. The example process 300 is used to monitor real-time data of crucial well operation parameters, such as gas flowrates, pressures, temperatures, and other geomechanical parameters of gas storage wells and reservoir. The example process 300 incorporates real-time micro-seismic and downhole pressure and temperature monitoring features. The data generated during the example process 300 is displayed on a user-friendly interface including various dashboards and reports, enabling a comprehensive performance analysis at field and well levels. The data generated during the example process 300 can automatically integrate surface and subsurface data, including microseismic data, to automatically update gas storage models and issue recommendations for well and reservoir management.

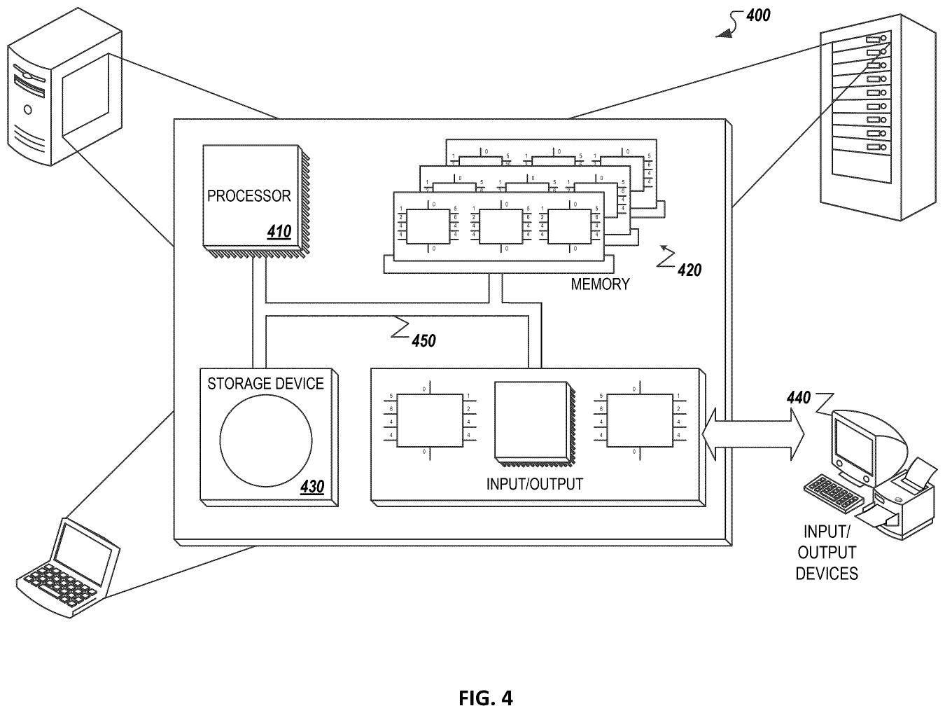

FIG. 4 depicts a block diagram illustrating a computing system 400, in accordance with some example implementations. Referring to FIGS. 1A and 1B, the computing system 400 can be used to implement the server system 102 and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

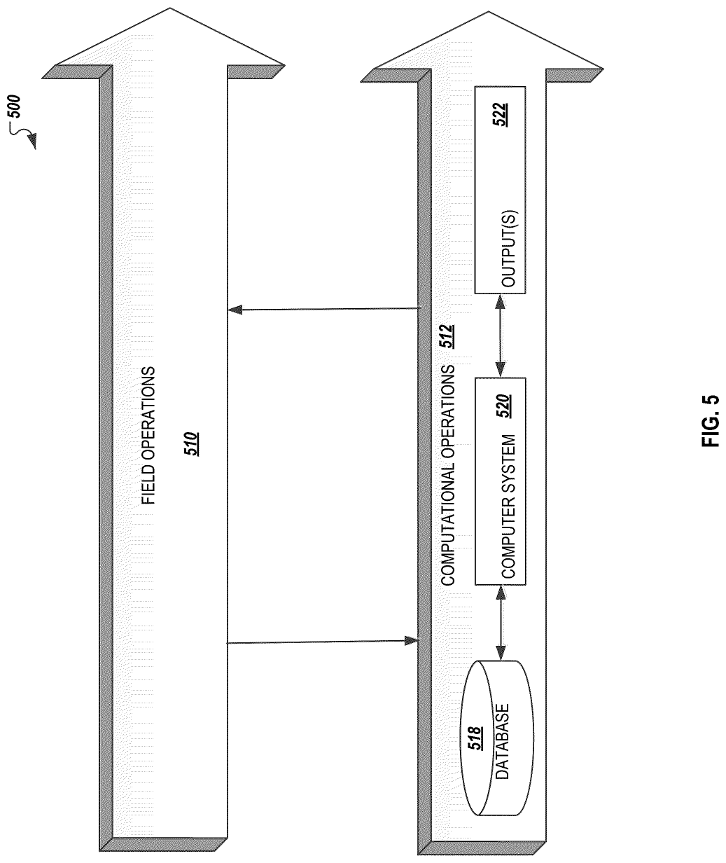

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving, by one or more processors from probes, probe data indicative of gas storage, the probe data being collected by probes included in operating wells and observation wells within a field, the probe data comprising surface data and subterranean data indicative of a health of a gas storage reservoir within the field; determining, by the one or more processors, by using a gas storage model, a gas storage status, the gas storage model correlating the surface data and the subterranean data within the field; providing, by the one or more processors, a gas storage assessment report comprising a pressure map reflecting the gas storage status within the field; and triggering, by the one or more processors, an operation affecting the gas storage within the field.

Example 2. The computer-implemented method of example 1, wherein the probe data comprises wellhead data, downhole parameters, and micro-seismic data.

Example 3. The computer-implemented method of any one of the previous examples, further comprising: determining, by the one or more processors, that the probe data is outside an operational range; and generating, by the one or more processors, an alert for transmission to one or more computing devices.

Example 4. The computer-implemented method of any one of the previous examples, wherein the gas storage status comprises sustainability, integrity, and safety of gas storage surface and subterranean assets.

Example 5. The computer-implemented method of any one of the previous examples, further comprising: determining, by the one or more processors, that the gas storage status is outside an operational range; and generating, by the one or more processors, an action plan comprising one or more remediation operations.

Example 6. The computer-implemented method of any one of the previous examples, further comprising: transmitting, by the one or more processors, the one or more remediation operations configured to adjust at least one configuration setting of at least one of one or more devices.

Example 7. The computer-implemented method of any one of the previous examples, further comprising: determining, by the one or more processors, consequences associated with the action plan.

Example 8. The computer-implemented method of any one of the previous examples, further comprising: updating, by the one or more processors, the gas storage model based on the consequences associated with the action plan.

Example 9. The computer-implemented method of any one of the previous examples, wherein the operation comprises a reservoir management operation, an injection strategy, or a re-production strategy.

Example 10. A computer-implemented system comprising: memory storing application programming interface (API) information; and a server performing operations comprising: receiving, from probes, probe data indicative of gas storage, the probe data being collected by probes included in operating wells and observation wells within a field, the probe data comprising surface data and subterranean data indicative of a health of a gas storage reservoir within the field; determining by using a gas storage model, a gas storage status, the gas storage model correlating the surface data and the subterranean data within the field; providing a gas storage assessment report comprising a pressure map reflecting the gas storage status within the field; and triggering an operation affecting the gas storage within the field.

Example 11. The computer-implemented system of example 10, wherein the probe data comprises wellhead data, downhole parameters, and micro-seismic data.

Example 12. The computer-implemented system of any one of the previous examples, further comprising: determining, by the one or more processors, that the probe data is outside an operational range; and generating, by the one or more processors, an alert for transmission to one or more computing devices.

Example 13. The computer-implemented system of any one of the previous examples, wherein the gas storage status comprises sustainability, integrity, and safety of gas storage surface and subterranean assets.

Example 14. The computer-implemented system of any one of the previous examples, wherein the operations further comprise: determining that the gas storage status is outside an operational range; and generating, by the one or more processors, an action plan comprising one or more remediation operations.

Example 15. The computer-implemented system of any one of the previous examples, wherein the operations further comprise: transmitting the one or more remediation operations configured to adjust at least one configuration setting of at least one of one or more devices.

Example 16. The computer-implemented system of any one of the previous examples, wherein the operations further comprise: determining consequences associated with the action plan.

Example 17. The computer-implemented system of any one of the previous examples, wherein the operations further comprise: updating the gas storage model based on the consequences associated with the action plan.

Example 18. The computer-implemented system of any one of the previous examples, wherein the operation comprises a reservoir management operation, an injection strategy, or a re-production strategy.

Example 19. A non-transitory computer-readable media encoded with a computer program, the computer program comprising instructions that when executed by one or more computers cause the one or more computers to perform operations comprising: receiving, from probes, probe data indicative of gas storage, the probe data being collected by probes included in operating wells and observation wells within a field, the probe data comprising surface data and subterranean data indicative of a health of a gas storage reservoir within the field; determining by using a gas storage model, a gas storage status, the gas storage model correlating the surface data and the subterranean data within the field; providing a gas storage assessment report comprising a pressure map reflecting the gas storage status within the field; and triggering an operation affecting the gas storage within the field.

Example 20. The non-transitory computer-readable media of example 19, wherein the probe data comprises wellhead data, downhole parameters, and micro-seismic data.

What is claimed is:

1. A computer-implemented method comprising:
receiving, by one or more processors from probes, probe data indicative of gas storage, the probe data being collected by probes included in operating wells and observation wells within a field, the probe data comprising surface data and subterranean data indicative of a health of a gas storage reservoir within the field;
determining, by the one or more processors, by using a gas storage model, a gas storage status, the gas storage model correlating the surface data and the subterranean data within the field;
providing, by the one or more processors, a gas storage assessment report comprising a pressure map reflecting the gas storage status within the field; and
triggering, by the one or more processors, an operation affecting the gas storage within the field.

2. The computer-implemented method of claim 1, wherein the probe data comprises wellhead data, downhole parameters, and micro-seismic data.

3. The computer-implemented method of claim 2, further comprising:
determining, by the one or more processors, that the probe data is outside an operational range; and
generating, by the one or more processors, an alert for transmission to one or more computing devices.

4. The computer-implemented method of claim 1, wherein the gas storage status comprises sustainability, integrity, and safety of gas storage surface and subterranean assets.

5. The computer-implemented method of claim 4, further comprising:
determining, by the one or more processors, that the gas storage status is outside an operational range; and
generating, by the one or more processors, an action plan comprising one or more remediation operations.

6. The computer-implemented method of claim 5, further comprising:
transmitting, by the one or more processors, the one or more remediation operations configured to adjust at least one configuration setting of at least one of one or more devices.

7. The computer-implemented method of claim 5, further comprising:
determining, by the one or more processors, consequences associated with the action plan.

8. The computer-implemented method of claim 7, further comprising:
updating, by the one or more processors, the gas storage model based on the consequences associated with the action plan.

9. The computer-implemented method of claim 1, wherein the operation comprises a reservoir management operation, an injection strategy, or a re-production strategy.

10. A computer-implemented system comprising:
memory storing application programming interface (API) information; and
a server performing operations comprising:
receiving, from probes, probe data indicative of gas storage, the probe data being collected by probes included in operating wells and observation wells within a field, the probe data comprising surface data and subterranean data indicative of a health of a gas storage reservoir within the field;
determining by using a gas storage model, a gas storage status, the gas storage model correlating the surface data and the subterranean data within the field;
providing a gas storage assessment report comprising a pressure map reflecting the gas storage status within the field; and
triggering an operation affecting the gas storage within the field.

11. The computer-implemented system of claim 10, wherein the probe data comprises wellhead data, downhole parameters, and micro-seismic data.

12. The computer-implemented system of claim 11, wherein the operations further comprise:
determining, by the one or more processors, that the probe data is outside an operational range; and
generating, by the one or more processors, an alert for transmission to one or more computing devices.

13. The computer-implemented system of claim 10, wherein the gas storage status comprises sustainability, integrity, and safety of gas storage surface and subterranean assets.

14. The computer-implemented system of claim 13, wherein the operations further comprise:
determining that the gas storage status is outside an operational range; and
generating an action plan comprising one or more remediation operations.

15. The computer-implemented system of claim 14, wherein the operations further comprise:
transmitting, by the one or more processors, the one or more remediation operations configured to adjust at least one configuration setting of at least one of one or more devices.

16. The computer-implemented system of claim 14, wherein the operations further comprise:
determining, by the one or more processors, consequences associated with the action plan.

17. The computer-implemented system of claim 16, wherein the operations further comprise:
updating, by the one or more processors, the gas storage model based on the consequences associated with the action plan.

18. The computer-implemented system of claim 10, wherein the operation comprises a reservoir management operation, an injection strategy, or a re-production strategy.

19. A non-transitory computer-readable media encoded with a computer program, the computer program comprising instructions that when executed by one or more computers cause the one or more computers to perform operations comprising:
receiving, from probes, probe data indicative of gas storage, the probe data being collected by probes included in operating wells and observation wells within a field, the probe data comprising surface data and subterranean data indicative of a health of a gas storage reservoir within the field;
determining by using a gas storage model, a gas storage status, the gas storage model correlating the surface data and the subterranean data within the field;
providing a gas storage assessment report comprising a pressure map reflecting the gas storage status within the field; and
triggering an operation affecting the gas storage within the field.

20. The non-transitory computer-readable media of claim 19, wherein the probe data comprises wellhead data, downhole parameters, and micro-seismic data.
